(19) United States
(12) Patent Application Publication
(10) Pub. No.: US 2016/0116887 A1
(43) Pub. Date: Apr. 28, 2016

(54) IMAGING DEVICE, CONTROL DEVICE, AND INFORMATION REPRODUCTION DEVICE

(71) Applicant: Hitachi Consumer Electronics Co., Ltd., Yokohama-shi, Kanagawa (JP)

(72) Inventor: Fumio ISSHIKI, Tokyo (JP)

(21) Appl. No.: 14/651,475

(22) PCT Filed: Dec. 12, 2012
(86) PCT No.: PCT/JP2012/082125

§ 371 Date: Dec. 7, 2015

(51) Int. Cl. G03H 1/04; H04N 5/378; H04N 5/225

(52) U.S. Cl. CPC G03H 1/0465; H04N 5/2253; H04N 5/378; G03H 2001/0473

(57) ABSTRACT

In an imaging element having a function for partially transmitting image data of a partial region on an image-capturing surface, when an input/output interface of the imaging element becomes a limitation factor of a frame rate, it is desired to improve the frame rate by devising a driving method. By providing a table for storing coordinate ranges of a plurality of regions, image data of the plurality of the coordinate ranges are continuously or alternately transmitted.

### TECHNICAL FIELD

The present invention relates to a high-speed camera element (imaging device) for which a high resolution and a short imaging period (high frame rate) are required, and to a control device and an information reproduction device thereof.

### BACKGROUND ART

As a background art, a technique described in Patent Document 1 has been known. Patent Document 1 describes that “an object is to greatly improve the throughput of the image sensor by greatly reducing an A/D conversion time when a readout region is limited”, and, as its configuration, describes an imaging device that can greatly improve the throughput when the readout region is limited by shortening the A/D conversion time when the readout region is limited.

### PRIOR ART DOCUMENT

### Patent Document

Patent Document 1: Japanese Patent Application Laid-Open Publication No. 2012-99909

### SUMMARY OF THE INVENTION

### Problems to be Solved by the Invention

Patent Document 1 has proposed a device having a configuration that improves the throughput of the cameral element by devising a connection method of AD converters at the time when a readout region on an imaging plane is limited to a partial rectangular region (partial region transmission). However, in this conventional configuration, a camera element has already been provided with a sufficient number of AD converters inside thereof, and therefore, this conventional configuration has a problem that the effect of the improvement in the frame rate cannot be obtained as the whole element when a speed of a data output interface of an imaging element chip reaches an upper limit faster than that of the AD converters.

The present invention has been made in order to solve the above-described problem, and an object of the present invention is to provide an imaging device, a control device, and an image reproduction device that can improve the frame rate effectively at a low cost with a reduced power consumption by improving a partial region transmitting function in a camera element.

### Means for Solving the Problems

The above-described object can be achieved by using, for example, an image sensor having a partial transmitting function.

### Effects Of The Invention

According to the present invention, the efficiency of operations of the input/output interface of data of the camera element at the time of a partial region transmitting process can be improved, and an imaging device, a control device, and an image reproduction device that improve a frame rate at a low cost with a reduced power consumption as a whole device can be provided.

### BRIEF DESCRIPTIONS OF THE DRAWINGS

FIGS. 1(a)-1(d2) are views showing a scanning method for an imaging region of a camera element in a device according to the present invention;

FIG. 2 is a view showing a structure of connection between a camera element and an image processing circuit in a conventional imaging device;

FIGS. 3(a1)-3(b2) are views showing a switching method of the imaging region of the camera element in the device according to the present invention;

FIG. 4 is a view showing an inner circuit configuration of the camera element in the device according to the present invention;

FIG. 5 is a view showing a pixel circuit configuration of the camera element in the device according to the present invention;

FIGS. 6(a)-6(d2) are views showing a configuration of an imaging device/control device on which the camera element is mounted according to the present invention;

FIGS. 7(a)-7(c) are views showing a configuration of an information reproduction device/control device on which the camera element is mounted according to the present invention;

FIGS. 8(a)-8(b) are views for use in explaining a scanning method of a mirror angle in a holographic memory device; and

FIGS. 9 (a) -9 (c) are views showing a shape of a reproduced light image of the holographic memory device and a setting example of a shape of a partial transmission region.

### BEST MODE FOR CARRYING OUT THE INVENTION

Hereinafter, devices (an imaging device, a control device and an information reproduction device) according to the present invention will be described. For easily understanding, in each view, note that explanation will be made by partially denoting the same reference symbol to parts showing the same function.

First, the background on which the problem to be solved by the present invention and the object of the present invention will be supplementally explained.

In an automatic control device of an image recognizing system, a high-speed and high-resolution camera element has been demanded for higher speed and more accurate control.

Moreover, also for an information storage device for use in computers, particular for a storage device of a holographic memory system for new generation, a high-speed camera element with a high resolution has also been required for instantaneously reading and retrieving a large amount of information.

In such a high-speed camera with high resolution, the upper limit of a data transfer speed is practically determined by the number of terminals (the number of pins) (the number of signal lines) that can be extended from a chip of a sensor serving as an imaging element. In recent years, a CMOS camera sensor has made a mainstream as the high speed camera.

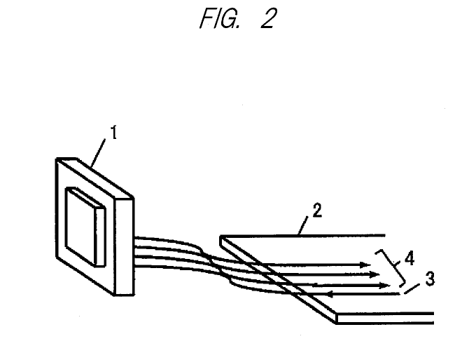

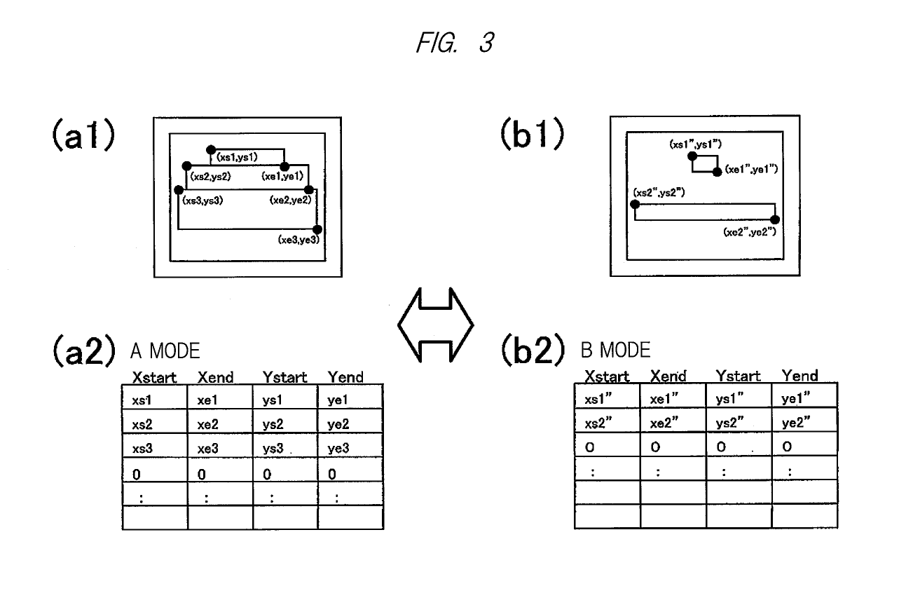

FIG. 2 shows an example of connection of signal lines in such a CMOS camera. A camera element 1 and an image processing substrate 2 are connected to each other by a serial communication line 3 and an image transmission line 4. The image transmission line 4 is made of a plurality of parallel signal lines. The serial communication line 3 is used for setting and confirming a camera operation state. The image transmission line 4 is used for outputting an image detected by the camera element from the camera element. Normally, when the number of signal lines of the camera element 1 becomes larger, the package thereof becomes larger due to the increase of the number of pins to cause high cost, and therefore, the number of signal lines (number of pins) is reduced by normally using a serial communication for the camera operation setting for which the high speed is unnecessary. On the other hand, the number of the image transmission lines 4 has particularly increased so as to reach several tens in recent years for a high-speed image data transmission.

In accordance with the requirement for a higher-speed camera with higher resolution, data to be read out from the camera element is required to provide several megabytes per one sheet as a high-resolution camera. Moreover, because of image capturing at the high speed with the number of frames exceeding 200 sheets per one second, the imaged data per one second is required so as to reach 1 to 3 gigabytes.

In such a high-speed camera element, the number of image transmission lines 4 reaches several hundreds, and therefore, a larger-size package is required, and the cost is further increased, which results in a problem. In order to achieve a high frame rate of the camera element, note that a CMOS camera having the same number of AD converters as the number of horizontal pixels within an imaging region has appeared, and the present invention deals with such a camera element achieving the high speed.

For use in a control device or others, such camera elements with the requirement of the high speed have often a case in which image data of all the regions in which images can be captured on the camera element is not always required for controlling the device. Therefore, some of the camera elements are provided with a partial region transmitting function which extracts only a required partial rectangular region of the captured image regions and can transmit and output the image data of only the region. If this function can be effectively utilized, the frame rate of the camera element can be increased to be higher than usual by reducing the amount of the practically-transmitted data even when the package having the same number of pins is used. By increasing the frame rate, a speed for control in a control device such as an appearance inspection device can be increased.

However, a high-speed operation is required as a specification of the camera is increased, and the number of terminals of a data output interface of the camera element chip is increased, and therefore, the number reaches the limitation of the package on which the chips are mounted. Thus, the data transmission speed of the camera element is limited by the package, and therefore, there have been many cameras having such a design that the AD conversion time and data transmission time required for outputting image data corresponding to one horizontal line out of the camera element have the same period of times as each other. In such a camera element, the amount of data to be transmitted becomes large when the lateral width of the partially-transmitted region is wide, and therefore, the AD conversion process finishes first, and a waiting time until the data output from the camera element finishes becomes a loss time. On the other hand, when the lateral width of the partially-transmitted region is narrow, the amount of image data becomes small, and therefore, the data output from the camera element finishes first, and awaiting time until the AD conversion finishes becomes a loss time.

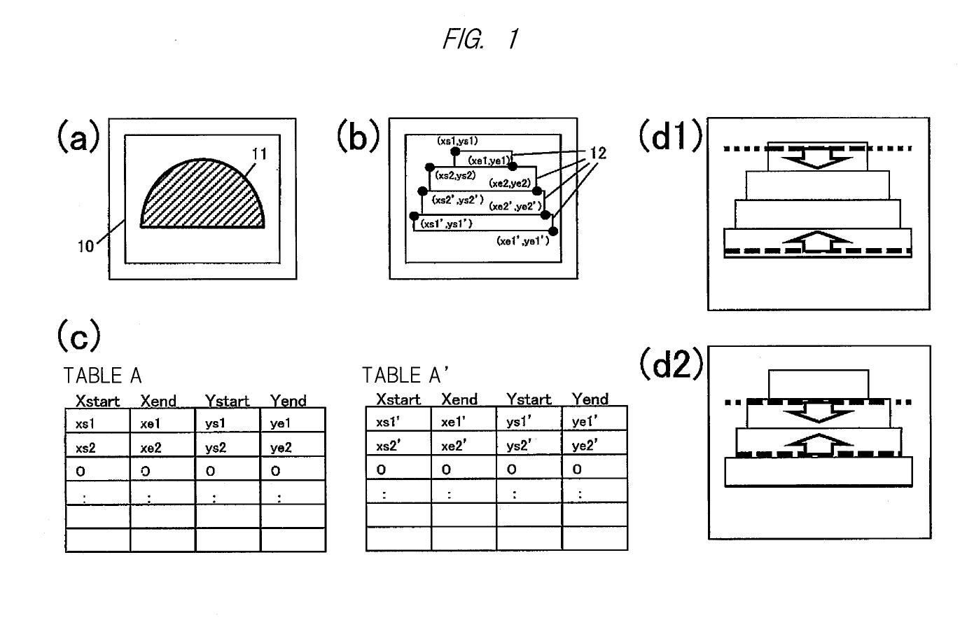

Here, as an example, a case of acquirement of an image in a region as shown in FIG. 1 is considered.

For example, when an image of a semicircular imaging region 11 of an image capture enable range 10 as a whole is efficiently obtained as shown in FIG. 1(a), if the region is divided into a plurality of (four) rectangular regions 12 as shown in FIG. 1(b) and image data in each region is successively read, the image acquirement can be efficient while transmission of unnecessary portions on the upper side of the circular arc is eliminated, in comparison with a case of reading simply in one rectangular region through partial transmission. However, the rectangular regions 12 have the wide lateral width and the narrow lateral width as described above, and therefore, the case in which the waiting time for the data output becomes the loss time and the case in which the waiting time for the finish of the AD conversion time becomes the loss time are mixed as described above in some cases. In these cases, if these losses are eliminated, the frame rate of operations of the camera element can be increased to be higher.

Moreover, a case in which the shape of the partial region to be acquired is desired to be switched so as to match with the timing of a video to be captured as shown in FIG. 3(a1) and FIG. 3(b1) is considered. This process is actually required when a controlling process in a high-speed control device is performed so as to match with the timing of a movement of an imaging object. In this case, it is required to rewrite the setting at the time of switching by using the serial communication so as to match with the switching timing. However, the frame rate is undesirably lowered by the time required for the communication. In the serial communication, when a signal having several tens of bytes normally required for operation settings of the camera element is transmitted and rewritten through a serial communication line having a limited speed (normally about several hundreds of kilobytes per second), a period of time of about 0.1 to 0.3 milliseconds is required only by this process. In a case of a camera having 1000 frames per second, this requirement means that the operation speed is lowered by about 10% to 30% because of this time loss. Therefore, if the shape of the partial region can be switched without a load onto the serial communication, the loss of the serial communication time is eliminated, so that the frame rate can be improved.

Therefore, the imaging device, control device and information reproduction device according to the present invention are configured so that the camera element can be used at a higher frame rate while maintaining a cost by eliminating the losses as described above so as to increase the speed of the operations when the camera element having the partial region transmitting function is used for these devices.

Hereinafter, with reference to FIGS. 1 to 5, embodiments of the present camera element, an imaging device using the camera element, a control device and an information reproduction device will be described.

First, with reference to FIGS. 1 and 2, an outline of operations of the present camera element will be described.

In the present camera element, the function of the partial region transmission is made efficient by using two systems.

First, the first system will be described by using FIG. 1 again.

As shown in FIG. 1(a), for example, in a case of an image having a semicircular imaging region 11 of the image capture enable range 10 as a whole as an example, the region to be transmitted is divided first into a plurality of rectangular regions 12 each having a rectangular shape as shown in FIG. 1(b). Moreover, in accordance with the pattern of FIG. 1(b), two tables (table A and table A′) for use in storing an upper left coordinate and a lower right coordinate of each rectangle are prepared as shown in FIG. 1(c). When an image of the imaging region 11 is obtained, the narrowest region “(xs1, ys1)-(xe1, ye1)” and the widest region “(xs1′, ys1′)-(xe1′, ye1′)” are paired as shown in FIG. 1(d1), and image data of the two regions are outputted alternately through image transmission lines of the camera element for each of the scanning lines. Next, the narrower region “(xs2, ys2)-(xe2, ye2)” and the wider region “(xs2′, ys2′)-(xe2′, ye2′)” are paired, and image data of the two regions are outputted alternately through image transmission lines of the camera element for each of the scanning lines.

When the partial regions have rectangular regions having a wide lateral width portion (wide width portion) and a narrow lateral width portion (narrow width portion) depending on a location as seen in the drawings, image data of the wide width portion and image data of the narrow width portion are alternately transmitted, so that the average amount of transmission data is reduced to an intermediate value between them, and therefore, the maximum amount of transmission data of the image data outputted by the camera can be reduced, and the frame rate can be improved by the reduction even in the case of the same number of transmission lines. Even in the case of the same number of package pins, images can be transmitted at a frame rate which is higher than practical. Consequently, speeds of the control of the control device and operations of the information reproduction device can be increased.

Next, with reference to FIG. 3, the second system will be described.

FIG. 3 shows a case of the image having the semicircular imaging region as similar to FIG. 1(a). However, depending on control required in the control device and the information reproduction device, only the light quantity balance between some up/down and right/left portions may be detected in some cases except when the entire image is captured at a specific timing. However, image data of all the portions (FIG. 3(a1)) of the imaging region 11 are not necessarily always required, and a method is normally desired in some cases, the method continuously checking the image data of the partial regions as shown in FIG. 3(b1), and instantaneously acquiring the image data of the entire portion of the imaging region 11 as shown in FIG. 3(a1) only when the matched timing. A period of time required for transmitting an image is in proportion to the amount of area of image data to be transmitted in most cases. Therefore, as described above, the method of acquiring the image data of the entire portion at only the necessary time and acquiring only some regions having a small area at time except for that time as shown in FIG. 3(b1) can largely increase the frame rate in the state shown in FIG. 3(b1). However, for this process, it is required to switch between the state (A mode) of FIG. 3(a1) and the state (B mode) of FIG. 3(b1) at a high speed. However, as described above, these operation states are set by using the serial communication lines in the normal camera element, and therefore, the practical frame rate is reduced by 10 to 30 percent in some cases by only the rewriting of these operation settings by using the serial communication lines. Therefore, in the present configuration, as shown in FIG. 3(a2) and FIG. 3(b2), the instantaneous switching is achieved by providing a coordinate table corresponding to each of the A mode and B mode inside the camera element, previously storing a coordinate value indicating the region shape of each of the modes in the tables, and only giving a signal for switching these modes from the outside.

Thus, a high-speed feedback process can be performed at a high frame rate until a period of time immediately before the image capturing (in the B mode), and an image in the necessary area can be acquired in the A mode at only the matched timing, so that the matching accuracy of the timing can be improved, and therefore, the accuracy of the control of the control device can be enhanced.

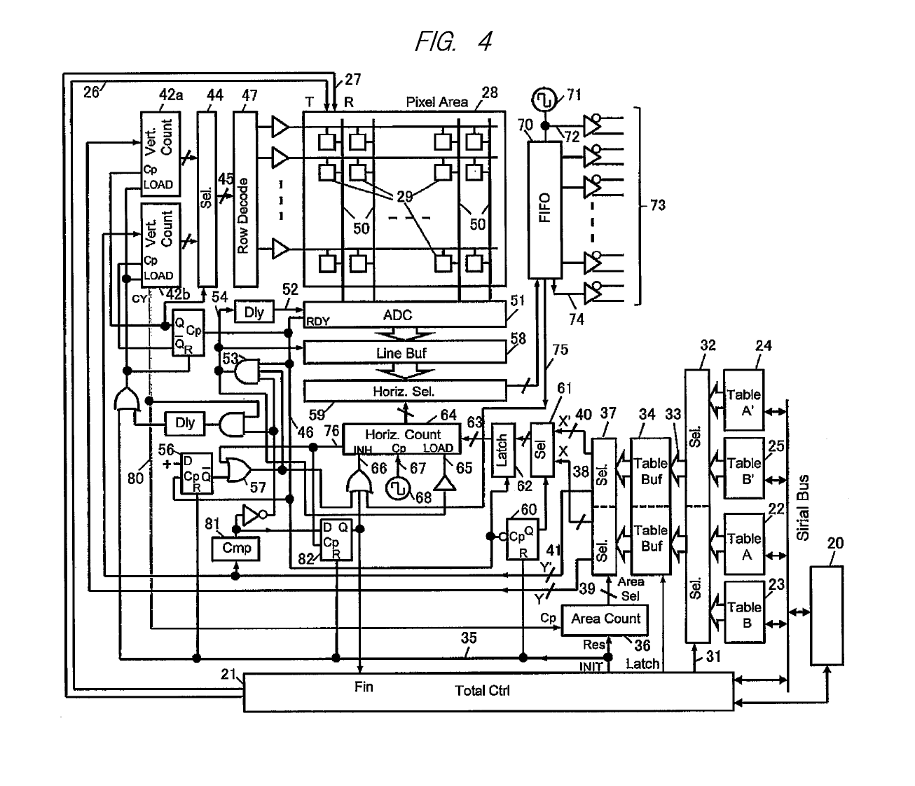

Next, a specific configuration and operations of inside of the camera element provided with these two systems will be described with reference to FIGS. 4 and 5.

FIG. 4 shows an entire configuration of circuits of the inside of the camera element. This corresponds to an internal circuit configuration of the camera element 1 shown in FIG. 2.

The camera element is designed to communicate with a controller 21 for controlling the entire camera element, and also to set each coordinate value of a table A22, a table B23, a table A′24 and a table B′25 and confirm the set value, by using a control input/output terminal 20 which is an input/output interface to/from an image processing substrate serving as a high-order system. The table A is provided with both functions of the table A of FIG. 1(c) and FIG. 3(a2), the table A′ is provided with both functions of the table A′ of FIG. 1(c) and FIG. 3(a2), the table B is provided with both functions of the table A in FIG. 1(c) and FIG. 3(b2), and the table B′ is provided with both functions of the table A′ in FIG. 1(c) and FIG. 3(b2).

First, the controller 21 starts the acquiring operation of the image based on a signal from the control input/output terminal 20. The controller 21 sends a pulse to a pixel transfer signal 26 and a pixel reset signal 27 so as to reset the pixel prior to exposure. The pixel transfer signal 26 and the pixel reset signal 27 are connected to each of pixel units 29 located inside a pixel array region 28. A specific circuit example of inside of each of the pixel units 29 is illustrated in FIG. 5. Inside the pixel unit, each of the transistors is driven by using the pixel transfer signal 26, the pixel reset signal 27 and a vertical driving signal 28, so that movement of an optical detection charge inside each of the pixels is controlled. By sending a pulse for simultaneously turning on the pixel transfer signal 26 and the pixel reset signal 27, the charge inside the pixel is discharged and reset.

Next, when only the pixel transfer signal 26 is turned on at this time after a lapse of a predetermined time (exposure time), a charge that is proportional to the amount of received light of each pixel is moved to the gate of the output transistor 30 of the pixel unit. In this state, when the vertical driving signal 28 is turned on, a voltage that is proportional to the amount of received light of each pixel is outputted from each of the pixel units. Note that the pixel reset signals have practically a configuration which can individually drive each row, and are configured to obtain a more accurate signal of the amount of the received light at the time of a reading process by making a difference between the outputted voltage and a voltage immediately after the reset. However, this configuration is omitted from the following description.

A mode switching signal 31 for switching between the A mode and the B mode is previously determined before reaching this state. As each coordinate value of the table A22, table B23, table A′24 and table B′25, the values of the table A22 and the table A′24 are selected by a table selector 32 in the case of the A mode, and the values of the table B23 and the table B′25 are selected by the table selector 32 in the case of the B mode, and are latched in a table buffer 34 by each table latch signal 33, and stored therein. In these values, when the A mode and the B mode are switched, note that the mode can be instantaneously changed by simply sending a pulse to the table latch signal 33 after the switching by the mode switching signal 31.

Next, a read-out process of the amount of the received light of each of the pixels is started.

A pulse is outputted to an initializing signal 35 by the controller 21, so that the respective circuit units are initialized. In the initial state, a region counter 36 is reset. In this state, the upper left XY coordinates (xs1, ys1) and the lower right XY coordinates (xe1, ye1) of the rectangular region of the first narrow width portion, as well as the upper left XY coordinates (xs1′, ys1′) and the lower right XY coordinates (xe1′, ye1′) of the rectangular region of the first wide width portion, which are stored in the table buffer 34, are selected by the coordinate selector 37 in accordance with the value of a region counter 36, and are outputted as an X coordinate range signal 38 (xs1 and xe1), a Y coordinate range signal 39 (ys1 and ye1), an X′ coordinate range signal 40 (xs1′ and xe1′) and a Y′ coordinate range signal 41 (ys1′ and ye1′).

The Y coordinate range signal 39 is loaded by the initializing signal 35 into a vertical counter 42a so that the initial value of the vertical counter 42a is set to ys1. Similarly, the Y′ coordinate range signal 41 is inputted to a vertical counter 42b, and is loaded by the initializing signal 35 so that the initial value of the vertical counter 42b is set to ys1′ . These values are selected by a Y coordinate selector 44 in accordance with an output value of a flip-flop 43, and is outputted as a Y coordinate value 45. The flip-flop 43 takes an AD conversion completion signal 46 described later as its input, and alternately outputs a count value of the Y coordinate and a count value of the Y′ coordinate as the Y coordinate value 45 for every time of the AD conversion. The Y coordinate value 45 is supplied to a vertical decoder 47, and a selection driving line 48 at the corresponding Y coordinate position in the pixel array region 28 is driven, so that a voltage that is proportional to the amount of the detected light is outputted from each of the pixel units 29 aligned laterally on line and driven by this selection driving line 48. These outputted voltages are inputted to an AD converter 51 through each vertical signal line 50, and are triggered to be subjected to the A/D conversion by an AD conversion starting signal 52. Note that the AD conversion starting signal 52 is generated by time-delaying an AD conversion start permitting signal 54 outputted from an AND gate 53 by using a time delaying circuit 55. Immediately after the initialization by the initializing signal 35, the output of a flip-flop 56 is supplied to the above-described AND gate 53 through an OR gate 57 so that the AD conversion start permitting signal 54 is turned on. Therefore, even in a state that all the counters are stopped in their operations, the AD converter 51 can start the AD conversion operation after a lapse of the delay time by the time delay circuit 55. Moreover, the AD conversion start permitting signal 54 is turned on, so that a first initial value is loaded into a horizontal counter described later. Furthermore, the AD conversion start permitting signal 54 is supplied as a latch input for a line buffer 58. After completion of the AD conversion, the AD conversion value is stored and maintained in the line buffer 58 at a rising timing of the latch input, so that the line buffer 58 continuously supplies the maintained AD conversion value to a horizontal selector 59.

On the other hand, the X coordinate range signal 38 and the X′ coordinate range signal 40 are selected by an X coordinate selector 61 based on the value of the flip-flop 60, are maintained in an X coordinate range value buffer 62, and are outputted as an X coordinate range value signal 63. The above-described flip-flop 60 takes an AD conversion completion signal described later as its input, and is inverted every time the AD conversion starts. Thus, the above-described X coordinate range value signal 63 has the value of the X coordinate range signal 38 (xs1 and xe1) immediately after the initialization, and thereafter, the X coordinate range value (xs1 and xe1) and the X′ coordinate range value (xs1′ and xe1′) are alternately outputted each time the AD conversion is resumed. Note that the above-described X coordinate range value buffer 62 is a rising edge trigger input.

The X coordinate range value signal 63 is supplied to the horizontal counter 64 so as to determine a counting range of the horizontal counter. The horizontal counter has inputs of an X coordinate initial value loading signal 65, an operation inhibition signal 66 and a horizontal scanning clock signal 67. Note that the X coordinate initial value loading signal 65 is a rising trigger input. Moreover, in the initial state, as the input of the operation inhibition signal 66, the output of the above-described flip-flop 56 is supplied through the above-described OR gate 57 so that a state of the input is turned on, and therefore, the operation of the horizontal counter 64 is locked in the initial state. This locked state is released by the completion signal of the first AD conversion.

Moreover, the X coordinate initial value loading signal 65 is generated by the gate delay of the AD conversion start permitting signal 54, and the first initial value has been already loaded to the horizontal counter 64 by turning on the AD conversion start permitting signal 54 as described above.

Since the horizontal scanning clock signal 67 is always supplied by a horizontal scanning clock oscillation circuit 68, the horizontal counter starts its counting operation as soon as the operation inhibition signal 66 is released.

Note that, at the same time as the start of the first counting operation by the horizontal counter by the above-described completion signal of the first AD conversion, a clock is supplied to the vertical counter 42a for counting the Y coordinate value through the flip-flop 43 by the AD conversion completion signal 46, so that the vertical counter is counted up. Also, at this time, the Y coordinate count value of the vertical counter 42b is selected by the Y coordinate selector 44, and is outputted as the Y coordinate value 45. Simultaneously, since the AD conversion start permitting signal 54 is turned on, the AD conversion start signal 52 is supplied through the time delay circuit 55, so that the AD converter 51 automatically starts a second conversion.

The horizontal counter, which has started a counting operation, counts the X coordinate value in synchronization with the clock within a range given to the X coordinate range value signal 63, and outputs the counted X coordinate value and clock. The horizontal selector 59 receives the counted X coordinate value and the clock, and selects an AD conversion value at the horizontal coordinate position corresponding to the counted value among the AD conversion values supplied from the line buffer 58, and outputs the resulting value to a FIFO buffer 70 (first-in and first-out type buffer).

The FIFO buffer 70 parallel-outputs the AD conversion values received from the horizontal selector 59 from a differential transmission output 73 in synchronization with a transmission clock 72 generated by the differential transmission clock oscillator 71. When the FIFO buffer 70 does not have data in the buffer, note that the FIFO buffer 70 turns off a data valid signal 74 in order to indicate the data empty state. The data valid signal 74 and the transmission clock 72 are outputted together with each other by the differential transmission output 73. Moreover, when the data stored in the buffer have reached the upper limit of storage to be completely filled, the FIFO buffer 70 outputs a buffer-full signal 75 indicating the completely filled state. The buffer-full signal 75 is inputted to the operation inhibition signal 66 of the horizontal counter through a gate, and the counting operation is temporarily stopped during a period of the filled state of the buffer so as to provide a standby state until the FIFO buffer 70 has a space.

When the AD conversion values of all the single horizontal line within the X coordinate range are transferred to the FIFO buffer, and then, when the count value of the horizontal counter 64 exceeds the X coordinate range, the horizontal counter 64 outputs an X count full signal 76 to stop the counting operation, and also informs the AND gate 53 of the operation stop of the horizontal counter through the OR gate 57, so that the AND gate 53 turns the AD conversion start permitting signal 54 on again so as to start the next AD conversion.

By turning the AD conversion completion signal 46 on at the same time with the above-described operation, the flip-flop 43 is again inverted, and the vertical counter 42b is counted up through the flip-flop 43 at this time, and at the same time, the Y coordinate count value of the vertical counter 42a is outputted as the Y coordinate value 45 by the Y coordinate selector 44.

Moreover, since the AD conversion start permitting signal 54 is turned on again as described above, the X coordinate initial value load signal 65 is turned on, and the X coordinate initial value is loaded again to the horizontal counter 64, so that the X count full signal 76 is released, and the horizontal counter 64 starts a second counting operation of the X coordinate value again.

Furthermore, since the AD conversion start permitting signal 54 is turned on again as described above, the AD converter 51 starts a next third AD conversion operation.

In this manner, during the second counting operation of the X coordinate range by the horizontal counter, the AD converter previously performs the third AD conversion operation.

Similarly, during an N-th counting operation of the X coordinate range by the horizontal counter, the AD converter operates so as to perform an (N+1)-th AD conversion which is one-step-advance AD conversion.

Thereafter, such an operation is repeated until the Y coordinate count value of the vertical counter 42b exceeds the Y coordinate range value. When the Y coordinate count value exceeds the Y coordinate range value, a Y count full signal 80 is outputted by the vertical counter 42b.

Thus, an image data acquisition for one rectangular region is completed.

Successively, the above-described Y count full signal 80 is inputted to the region counter 36 as a clock pulse, and the region counter 36 is counted up, so that new coordinate regions (X coordinate region, Y coordinate region, X′ coordinate region and Y′ coordinate region) are outputted by the coordinate selector 37.

Simultaneously, similarly by the Y count full signal 80, the value of a new Y coordinate range is set to the vertical counter 42a, and the value of a new Y′ coordinate range is set to the vertical counter 42b. Moreover, the values of the X coordinate range and the X′ coordinate range to be supplied to the X coordinate range value buffer 62 are updated, and the output values of the X coordinate range value buffer 62 are also updated to these values of the new X coordinate range and new X′ coordinate range after the completion of the next AD conversion, and are supplied to the horizontal counter 64.

In this manner, the procedure from a period after the initialization to this stage is repeated by as many times as the number of the rectangular regions stored in the table, and lastly, when it is detected by a comparator 81 that the Y′ coordinate value (lower right coordinate) is set to 0 which is a value indicating the end, the output of a flip-flop 82 is inverted at the time of the next count full state (at the time of completion of FIFO transmission) of the horizontal counter, so that the operations of the horizontal counter 64 and the AD converter 51 are locked.

At this time, outputs of image data of all the regions whose coordinate values are set on the table from the FIFO buffer 70 have been completed.

By locking the operations of the horizontal counter 64 and the AD converter 51, all the circuits including the vertical counters 42a, 42b and the region counter 36 are entirely stopped, and the operations are completed.

Thus, a series of transmission processes of the image data of the plurality of the rectangular regions, which are stored and specified in the table, is completed.

By the present configuration and the operations explained above, the continuous and alternate transmission processes of the plurality of the rectangular regions as shown in FIG. 1(a) to FIG. 1(d2), and the high-speed switching processes of the shapes of the partial regions caused by the switching process of the plurality of the tables as shown in FIG. 3(a1) to FIG. 3(b2), can be simultaneously achieved.

In the present configuration, the plurality of the rectangular regions can be continuously transmitted by a single transfer starting instruction. For this reason, while it is required to reset the coordinates of the rectangular regions through the serial communication many times in the conventional camera element which can specify only one of the rectangular regions, the present configuration allows the operations at a higher frame rate because the loss of the serial communication time is eliminated.

Moreover, the present configuration can continuously and alternately transmit a plurality of pairs of the rectangular regions. In comparison with a case of only one rectangular region which can be specified, the plurality of pairs of the rectangular regions can be specified, so that an unnecessary region such as an upper peripheral portion having a semicircular shape while being more finely divided can be eliminated when an image of a partial region having a semicircular shape or a substantially elliptical shape is obtained, and therefore, the transmission efficiency can be enhanced, and the frame rate can be increased.

Furthermore, as explained above, in the present configuration, the AD converter operates so as to perform the (N+1)-th AD conversion which is one-step-advance AD conversion during the N-th counting operation of the X coordinate range by the horizontal counter. Besides, when the wide width region and the narrow width region of the rectangular region are alternately scanned for each horizontal line, by providing a double buffer configuration having the line buffer 58 and the FIFO buffer 70, variation in the amount of transmission of the image data in the twice-performed horizontal line scanning operation can be absorbed by the above-described double buffer configuration.

In this manner, as described above, even when the state that the standby for the data output time becomes the loss time and the state that the standby for the AD conversion completion time becomes the loss time are mixed, the variation in the amount of transmission of the image data can be absorbed by the above-described double buffer configuration by alternately using the rectangular region coordinate values of the table A and table A′ and alternately transmitting the image data of the wide-width rectangular region and the narrow-width rectangular region, so that an average amount of the transmission data can be provided to an intermediate value between the values of the wide width region and the narrow width region. That is, even when the state that the standby for the data output time becomes the loss time and the state that the standby for the AD conversion completion time becomes the loss time are mixed, these losses can be cancelled from each other, so that the frame rate of the camera element can be set to a higher value.

Moreover, in the present configuration, the shapes of the partial regions as shown in FIG. 3(a1) and FIG. 3(b1) can be switched by using the serial communication without rewriting the coordinate value of the table, and therefore, the shapes of the partial regions (A mode and B mode) can be switched without applying a load on the serial communication, and the loss of the serial communication time caused by the switching operation is eliminated, so that the frame rate can be improved.

Since the shapes of the partial regions as shown in FIG. 3 can be instantaneously switched by using only the table switching, a timing is easy to be matched on a captured video as described above. In a control device using the present camera element, the matching accuracy of the timing can be remarkably improved, and the control accuracy of the control device can be improved.

If the switching between the A mode and B mode is unnecessary, a configuration obtained by eliminating the table B23, the table B′25 and the table selector 32 from FIG. 4 may be adopted.

The operation at this time is the same as that in the case of the above-described configuration example of FIG. 4 except for the switching operation between the A mode and the B mode.

If the operations for alternately transmitting the wide-width rectangular region and the narrow-width rectangular region are unnecessary, the processes for alternately switching the table A and table A′ and switching the table B and table B′ become unnecessary. In this case, a configuration obtained by eliminating the table A′ 24, the table B′ 25, the table selector 32, the flip-flop 43, the vertical counter 42a, the Y coordinate selector 44, the flip-flop 60 and the X coordinate selector 61 may be adopted. With respect to wirings for use in selecting the wiring X or X′, or the wiring Y or Y′, note that the eliminated wiring is taken out, and the input of either the remaining X or X′ wirings or the remaining Y or Y′ wirings may be connected to the output at the later stage of the eliminated part. In this case, the circuit can be considerably simplified. Moreover, with respect to the connections of Q, /Q, and Cp caused by the elimination of the flip-flop 43, /Q and Cp may be connected.

The operation at this time is the same as that in the case of the above-described configuration example of FIG. 4 except for the switching operation of X or X′ or the switching operation of Y or Y′.

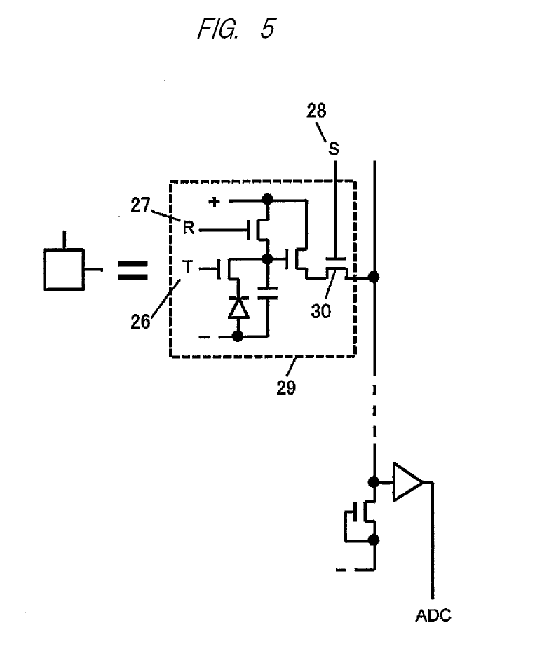

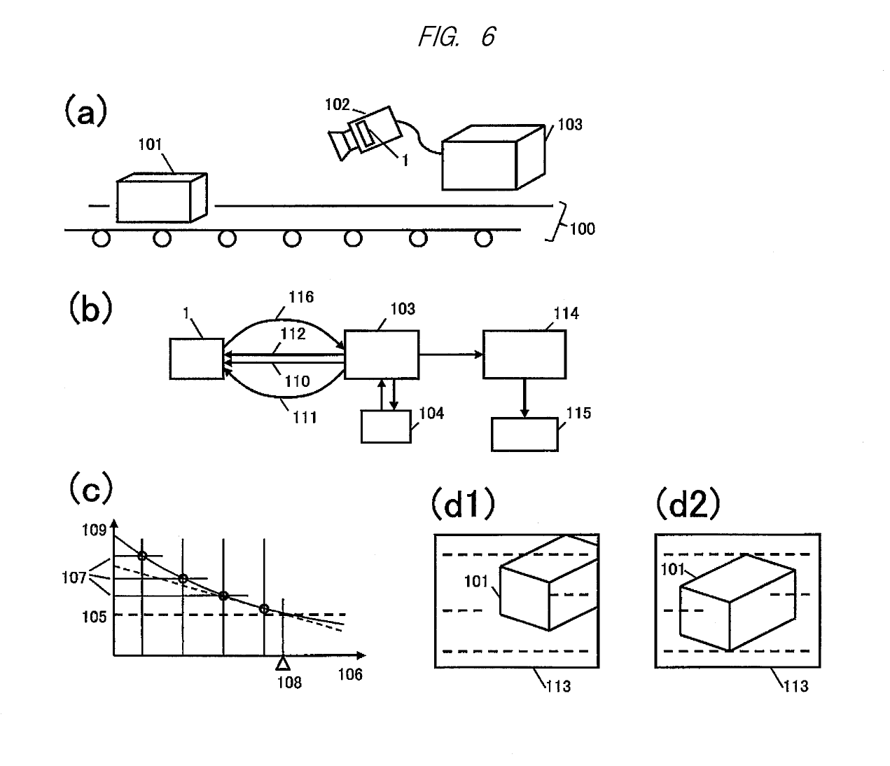

Next, with reference to FIG. 6, a configuration example of an imaging device using the present camera element (imaging element) and a control device thereof will be described.

FIG. 6(a) shows the configuration example of the imaging device using the above-described camera element and the control device based on the captured image.

An imaging object 101 mounted on a moving belt 100 is moved in a horizontal direction by the belt. A camera 102 in which the camera element 1 is embedded is arranged in order to capture images of this imaging object 101. The image data 116 outputted by the camera is supplied to an image analyzing device 103 to estimate the position of the imaging object 101 based on the image, and an image of the image-captured imaging object 101 is recorded. These members specifically configure an external appearance inspection device of a product.

Moreover, FIG. 6(b) shows connection with a device peripheral control system shown in FIG. 6(a). The positional information estimated by the image analyzing device 103 is outputted to a timing prediction device 104. As shown in FIG. 6(c), the timing prediction device 104 predicts a timing at which the imaging object 101 arrives at a specific position 105 by using a linear interpolation (straight-line interpolation) based on periodic positional information 107 of the image analyzing device 103 relative to time 106, and outputs this predicted arrival timing 108 to the image analyzing device 103. Note that a vertical axis of FIG. 6(c) indicates a position 109. Based on this predicted arrival timing 108, to the camera 102, the image analyzing device 103 outputs an A/B mode switching signal 110, an exposure timing signal 111 and a region shape signal 112 having the coordinate value information previously stored in the plurality of the coordinate value tables. Inside the camera 102, these signals are supplied to the camera element 1 inside the camera. In the camera element 1, the B mode is used for capturing an image required for the generation of the periodic positional information 107, and the A mode is used for capturing an image correctly caught in the center as shown in FIG. 6(d2). The camera element 1 selects the shape of the partial region to be image-captured in accordance with the above-described A/B mode switching signal 110, and captures an image of the imaging object 101 in accordance with an exposure timing signal 111. Thus, the image to be recorded by the image analyzing device 103 is prevented from being shifted as a whole as shown in FIG. 6(d1), and the imaging object 101 is captured in a correctly center-caught state within the imaging region 113 as shown in FIG. 6(d2). Moreover, information of the recorded image is outputted by the image analyzing device 103, and based on the information of the image, the destination of the movement is determined by a sorting control device 114 and is assigned to an appropriate movement destination by a driving device 115.

By using the camera element 1 described in the example and combining this camera element with the timing prediction device 104 in the present configuration, the partial region transmitting processes are effectively switched so that the frame rate can be increased, and therefore, a more accurate prediction is possible in the timing prediction as shown in FIG. 6(c), and the positional accuracy of the finally image-captured imaging object 101 can be enhanced, the image processing can be easily performed at a higher speed by the accurately captured image, so that a speed of the operations in the control device as a whole including the above-described devices can be increased.

Note that a device having a sorting function is exemplified as the control device in the above description. However, the camera element 1 can also be applied to a control device inside an information reproduction device as shown in the following description.

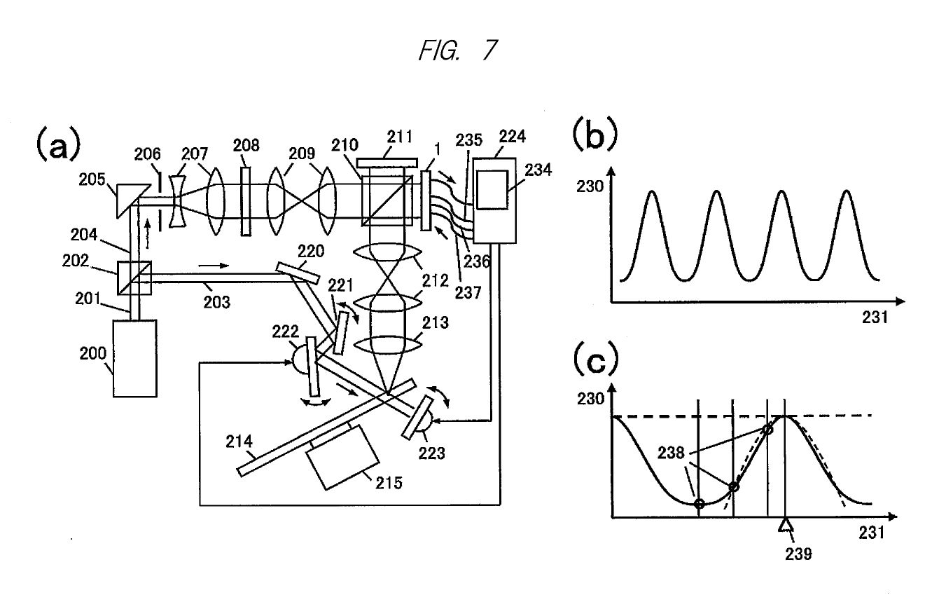

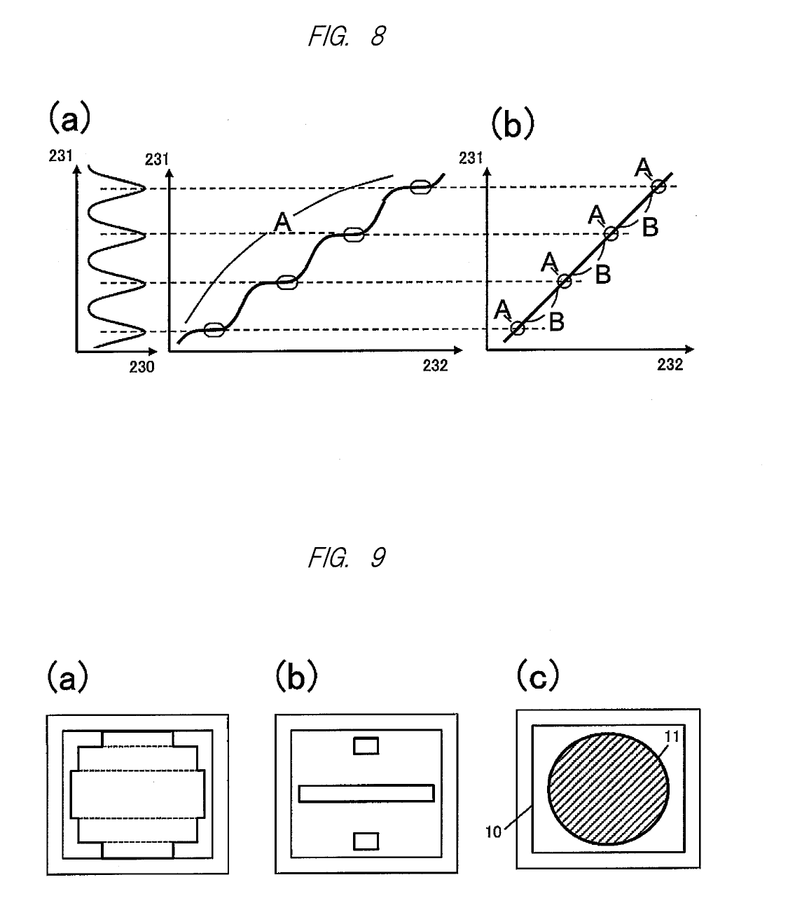

Next, with reference to FIGS. 7 and 8, a configuration example of an information reproduction device using the present camera element (imaging element) and a control device thereof will be described.

FIG. 7(a) shows a configuration of an information reproduction device of a holographic memory as an example of an imaging device using the above-described camera element and the control device based on the captured image.

A laser light beam 201 outputted by a laser light source 200 is divided by a beam splitter 202 into a reference light ray 203 and a signal light ray 204 that proceed toward the right side of the drawing.

The signal light ray 204 is reflected by a reflection mirror 205, and passes through a shutter 206, a beam expander 207, a phase mask 208 and a relay lens set 209, and then, is irradiated onto a light modulator 211 shown on the upper side of the drawing by a polarization beam splitter 210. The light modulator 211 is formed by combining a polarizing plate with a liquid crystal substance, and modulates the phase of light two-dimensionally by the liquid crystal. The light ray reflected by the light modulator 211 passes through the polarization beam splitter 210 and a relay lens 212, and is irradiated onto a disc 214 by an objective lens 213. The disc 214 is attached onto a spindle motor 215 and is rotatable, so that the irradiated position on the disc can be changed.

On the other hand, the reference light ray 203 is successively reflected by a reflection mirror 220, a first galvanometer 221 and a second galvanometer 222, and is irradiated onto the disc 214 so as to intersect with the irradiation position of the signal light ray, passes through the disc, is further reflected by a third galvanometer 223, and is returned onto the disc 214 with substantially the same angle as that of the outward path. Note that each galvanometer is a movable mirror whose angle is configured to be accurately controlled by the controller 224. Hereinafter, the mirror angle of the galvanometer is referred to as “the galvanomirror angle”.

The light ray returned to the disc 214 is diffracted by a hologram written on the disc, reversely traces the light path through which the signal light ray has previously proceeded, and passes through the objective lens 213 and the relay lens 212, is reflected rightward in the drawing by the polarization beam splitter 210, and made incident on the camera element 1. As the above-described camera element 1, the camera element that has been explained by using FIG. 1 and FIGS. 3 to 5 is utilized. The image data outputted from the camera element 1 is inputted to the controller 224, and is subjected to a signal process in the controller, and therefore, is recovered as digital data.

In the above-described configuration, note that the presence or absence of the supply of the signal light ray is switched by opening the shutter 206 in recording the data onto the disc, and closing the shutter 206 in reproducing the data from the disc.

Next, with reference to FIGS. 7(b) and 8, operations of the galvanometer and the camera element of the present information reproduction device will be described.

Regarding the light ray (reproduction light ray reproduced by a hologram) which has been read out from the hologram recorded on the disc 214 at a constant reference light angle cycle and which has been made incident on the camera element 1, a reproduced light intensity 230 which is an intensity of the light ray is changed in a waveform shape relative to the galvanomirror angle 231. Note that the angle of the reference light relating to the reproduction light ray is dependent on all the angles of the first galvanometer 221, the second galvanometer 222 and the third galvanometer 223 in the present configuration. However, the relationship in the angle is maintained among them in cooperation with the galvanometers with one another, and therefore, the galvanomirror angle described here may be considered to be any one angle of the typical galvanometer among them. Conventionally, in the information reproduction device of the holographic memory, the galvanomirror angle 231 is generally used in such an intermittent driving operation (stop-and-go operation based on the repeat of the movement and the stop) as moving from a peak to a peak and stops at the peak so that the wavy-changing reproduced signal intensity is at a peaked (maximized) position. This state is shown in FIG. 8(a). The FIG. 8(a) shows such an operation that the galvanomirror angle 231 is repetitively moved to and stopped at an angle at which the reproduced light intensity 230 is peaked. When the galvanomirror angle 231 is plotted with respect to time 232, a trace of the galvanomirror angle forms a terraced step shape. While this general method has such advantages as slightly allowing a temporal error in the image-capturing timing of the camera element so that the mechanical control of the mirror angle is easy in the image-capturing timing 233, this method has a problem of an upper limit in the operation speed, which results in difficulty in the increase in the reproduction speed of information as the information reproduction device because of the mechanical driving frequency limitation of the galvanometer due to the mechanical movement and stoppage operations.

Accordingly, in the present configuration, if the image-capturing timing of the camera element 1 is matched by using the camera element 1 explained in FIG. 1 and FIGS. 3 to 5 so as to detect an image of the reproduced light at the maximum position of each peak while the mirror angle is continuously rotated at a constant speed as shown in FIG. 8(b) instead of the repeat of the mechanical movement and stoppage of the mirror angle, the reproduction speed of information can be increased without being limited by the mechanical driving frequency limitation of the galvanometer.

Accordingly, by using the same method as the method explained in FIG. 6, the A mode is used for detecting the image of the reproduced light at the maximum position of each peak as shown in FIG. 8(b), and the B mode is used for detecting a partial image for use in predicting the maximum position of each peak, so that a speed of the feedback is increased.

Returning back to FIG. 7, the configuration will be subsequently described.

A timing prediction device 234 is provided inside the controller 224, and an image to be detected by the camera element 1 is normally partially detected in the B mode. Between the controller 224 and the camera element 1, an A/B mode switching signal 235, an exposure timing signal 236 and a region shape signal 237 are provided.

As shown in FIG. 7(c), in such assumption that the same curve as that of a previous peak is formed by using the periodic intensity information 238 that is the information of the reproduced light intensity 230 based on assumption of the change of the galvanomirror angle in proportion to the time 232, the timing prediction device 234 estimates a maximum intensity timing 239 that maximizes the reproduced light intensity from the curve, and outputs the timing. The controller 224 switches the A/B mode switching signal 235 when time arrives nearly at the maximum intensity timing 239 estimated by the timing prediction device 234, and drives the exposure timing signal 236 at time that is matched with the maximum intensity timing 239. Note that a pattern shown in FIG. 9(a) serving as the region shape corresponding to the A mode and a pattern shown in FIG. 9(b) serving as a region shape corresponding to the B mode are previously set in the coordinate value tables (table A and table B) relating to the camera element 1 by the region shape signal 237. Note that the region shape patterns shown in FIGS. 9(a) and 9(b) are assumed to be a circular image shown in FIG. 9(c) as the image of the hologram reproduced light to be detected by the camera element 1.

In the present configuration, by using the camera element 1 shown in the above-described embodiment in combination with the timing prediction device 234, the partial region transmitting patterns can be instantaneously switched while, the partial transmission region of the B mode is limited immediately before the switching, so that the frame rate can be increased, and therefore, a more accurate prediction can be made in the timing prediction shown in FIG. 9(c), the image of the hologram reproduced light to be finally captured can be matched at the high accuracy by using the timing that maximizes the intensity, and a hologram reproducing process is possible in the continuous rotating operation that are kept rotating continuously at a constant speed instead of the conventional galvanomirror angle control by the intermittent driving operation. Thus, the reproduction speed of information can be increased without being limited by the mechanical driving frequency limitation of the galvanometer.

Moreover, the present embodiment can also be expressed as follows. That is, the light information reproduction device for reproducing information from a light information recording medium by utilizing holography is provided with a laser light source for generating a reference light ray, an angle adjusting device for adjusting an incident angle of the reference light ray onto the light information recording medium, and an image-capturing element for detecting a diffracted light ray to be reproduced from the light information recording medium. The image-capturing element having a partial transmitting function is further provided with a table for storing coordinate ranges of two rectangular regions as a pair and a line buffer having one horizontal line or more, and has a function for acquiring the captured image data from the above-described two rectangular regions and for alternately transmitting the resulting data for each of the horizontal lines, and the output from the image-capturing element is inputted to the angle adjusting device.

Note that the present invention is not limited to the above-described embodiment, and includes various modified examples. For example, the above-described embodiment is explained in detail for easily explaining the present invention, and is not always limited to include all the configurations as described above. Moreover, a configuration of one embodiment can be partially replaced by a configuration of another embodiment, and the configuration of another embodiment can be added to the configuration of one embodiment. Furthermore, with another configuration can be added to, eliminated from, and replaced by a part of a configuration of each embodiment.

Moreover, a part or entire of each configuration described above may be configured by a hardware, or may be configured so as to be achieved by execution of a program by a processor. Furthermore, the control lines and the information lines considered to be required for explanation are shown, and all the control lines and information lines are not necessarily shown on the product. Practically, almost all the configurations may be considered to be mutually connected with one another.

### SYMBOL EXPLANATION

1 camera element

2 image processing substrate

3 serial communication line

4 image transmission line

10 image capture enable range

11 imaging region

12 rectangular region

20 control input/output terminal

21 controller

22 table A

23 table B

24 table A′

25 table B′

26 pixel transfer signal

27 pixel reset signal

28 pixel array region

29 pixel unit

30 output transistor

31 mode switching signal

32 table selector

33 table latch signal

34 table buffer

35 initializing signal

36 region counter

37 coordinate selector

38 X coordinate range signal

39 Y coordinate range signal

40 X′ coordinate range signal

41 Y′ coordinate range signal

42a and 42b vertical counter

43 flip-flop

44 Y coordinate selector

45 Y coordinate value

46 AD conversion completion signal

47 vertical decoder

48 selection driving line

50 vertical signal line

51 AD converter

52 AD conversion starting signal

53 AND gate

54 AD conversion start permitting signal

55 time delaying circuit

56 flip-flop

57 OR gate

58 line buffer

59 horizontal selector

60 flip-flop

61 X coordinate selector

62 X coordinate range value buffer

63 X coordinate range value signal

64 horizontal counter

65 X coordinate initial value loading signal

66 operation inhibition signal

67 horizontal scanning clock signal

68 horizontal scanning clock oscillation circuit

70 FIFO buffer

71 differential transmission clock oscillator

72 transmission clock

73 differential transmission output

74 data valid signal

75 buffer full signal

76 X count full signal

80 Y count full signal

81 comparator

82 flip-flop

100 moving belt

101 imaging object

102 camera

103 image analyzing device

104 timing prediction device

105 specific position

106 time

107 periodic positional information

108 predicted arrival timing

109 position

110 A/B mode switching signal

111 exposure timing signal

112 region shape signal

113 imaging region

114 sorting control device

115 driving device

116 image data

200 laser light source

201 laser light ray

202 beam splitter

203 reference light ray

204 signal light ray

305 reflection mirror

206 shutter

207 beam expander

208 phase mask

209 relay lens set

210 polarization beam splitter

211 light modulator

212 relay lens

213 objective lens

214 disc

215 spindle motor

220 reflection mirror

221 first galvanometer

222 second galvanometer

223 third galvanometer

224 controller

230 reproduced light intensity

231 galvanomirror angle

232 time

233 image-capturing timing

234 timing prediction device

235 A/B mode switching signal

236 exposure timing signal

237 periodic intensity information

238 maximum intensity timing

1. A light information reproduction device for reproducing information from a light information recording medium by utilizing holography, comprising:
a laser light source for generating a reference light ray;
an angle adjusting device for adjusting an incident angle of the reference light ray onto the light information recording medium; and
an imaging element for detecting a diffracted light ray reproduced from the light information recording medium,
wherein the imaging element, which has a partial transmitting function, is provided with a table for storing coordinate ranges of two rectangular regions as a pair and provided with a line buffer having one horizontal line or more, and has a function for acquiring imaging data from the two rectangular regions and for alternately transmitting the resulting data for each of the horizontal lines, and
the output from the imaging element is inputted to the angle adjusting device.

2. An image sensor element having a partial transmitting function, comprising:
a table for storing coordinate ranges of two rectangular regions as a pair; and
a line buffer having one horizontal line or more, both are included inside the element,
wherein the image sensor element has a function for acquiring imaging data from the two rectangular regions and for alternately transmitting the resulting data for each of the horizontal lines.

3. The image sensor element according to claim 2, further comprising:
a continuous transmitting function for a plurality of pairs of rectangular regions.

4. The image sensor element according to claim 2,
wherein, inside the element, a double buffer configuration of a line buffer and a FIFO buffer is used for transmitting image data.

5. An imaging device using the image sensor element according to claim 2 for capturing an image of a region having a substantially elliptical shape or a semicircular shape.

6. A hologram information reproduction device using the image sensor element according to claim 2.

7. An image sensor element having a partial transmitting function, comprising:
a table for storing coordinate ranges of a plurality of rectangular regions; and
a function for continuously and sequentially transferring the plurality of coordinate ranges stored in the table by a transferring instruction instructed once.

8. The image sensor element according to claim 7, further comprising:
a plurality of tables for storing coordinate ranges of a plurality of rectangular regions, which are inside the sensor element,
wherein the image sensor element has a selection function for selecting the plurality of the tables, and
the plurality of the tables can be instantaneously switched in accordance with a set value of the selection function.

9. An imaging device comprising:
the image sensor element according to claim 7;
a prediction device for predicting a next exposure timing based on a partially acquired image; and
a switching function for selecting a specific coordinate value table from a plurality of coordinate value tables,
wherein exposure is started by switching a shape of an image acquiring region based on the selected coordinate value table in accordance with a predicted timing of the prediction device so as to capture an image.

10. A control device using the imaging device according to claim 9.

11. A hologram information reproduction device using the image sensor element according to claim 7.
